(19) United States
(12) Patent Application Publication
(10) Pub. No.: US 2003/0074321 A1
(43) Pub. Date: Apr. 17, 2003

(54) Method and system for distribution of digital media and conduction of electronic commerce in an un-trusted environment

(75) Inventor: Ariel Peled, Even-Yehuda (IL)

Correspondence Address: G. E. EHRLICH (1995) LTD., c/o ANTHONY CASTORINA, SUITE 207, 2001 JEFFERSON DAVIS HIGHWAY, ARLINGTON, VA, 22202, US

(73) Assignee: Vidius Inc.

(21) Appl. No.: 10/270,290

(22) Filed: Oct. 15, 2002

Related U.S. Application Data
(60) Provisional application No. 60/328,823, filed on Oct. 15, 2001.

(51) Int. Cl. H04K 1/00

(52) U.S. Cl. 705/51

(57) ABSTRACT

A method for secure distribution of digital content held in at least one content server over an electronic network comprising the steps of: on said network setting up at least one centralized trusted entity for at least one of verifying, authenticating and auditing transactions; at said centralized trusted entity receiving a request from a vendor to verify a transaction involving a transaction client identified in said request; at said centralized trusted entity sending a verification request to said identified transaction client, receiving at said centralized trusted entity a verification reply from said transaction client, and, upon receipt of said verification reply sending a transaction approval signal to said vendor and to said content server, thereby to signal to said content server approval to release said digital content.

### RELATIONSHIP TO EXISTING APPLICATIONS

The present application claims priority from U.S. Provisional Patent Application No. 60/328,823 filed Oct. 15, 2001, the contents of which are hereby incorporated herein by reference.

### FIELD OF THE INVENTION

The present invention relates to the field of electronic commerce, and more particularly but not exclusively to the distribution of digital content using several parties.

### BACKGROUND OF THE INVENTION

Electronic commerce over the Internet, and especially the World Wide Web portion of the Internet, has grown in past few years at a phenomenal rate. Merchants and service providers from all sectors are taking advantage of the popularity of the World Wide Web by creating online points of sale on web sites, through which consumers can browse and order the provider's products and services.

Electronic commerce, however, is known to be susceptible to fraud. Electronic commerce therefore relies heavily on sophisticated mechanisms for managing trust and securing transactions to compensate for the lack of physical contact between vendor and customer or for the fear of credit card fraud, while wishing to maintain its unique traits of accessibility and availability to consumers worldwide.

Online vendors and services encompassing various aspects of modern trading rely heavily on transaction security measures to minimize fraud while handling mass volumes of transactions. Besides credit card fraud, the hazards of fraud mainly include misdirection of goods ordered and paid for by legal consumers or fraudulent extraction of goods from vendors.

The problem increases when dealing with digital media content, provided to the consumer through streaming media, multicasting, narrow casting or broadcasting, as the goods are of intangible nature and are usually delivered to the consumer immediately at the closure of the transaction.

Furthermore, in the case of digital media the issue of copyright protection or the security of such sensitive content is another problem related to the online distribution of digital media content. Fraud in this aspect is embodied in the misdirection of copyrighted or secured content to an unauthorized party.

Since mitigation of fraud is acute for the development of and growth of electronic commerce, and digital content distribution in particular, numerous methods and techniques for fraud detection and mitigation exist. Most of these methods attempt to assure the trustworthiness of the participating parties by using a third party or by transferring encryption keys. In most cases these are procedures that consume resources and may require the consumer's physical presence at the verifier.

While assuring the trustworthiness of each of the participating parties can help reducing the fraud level, it is, in general, better not to depend on the trustworthiness of each of the participating parties for the following reasons:

The trust requirement, assuring the vendor that the addressee of digital content is the consumer who ordered/purchased the content, acts as a barrier preventing emerging creators or vendors, who are less empowered than veterans, to enter the market. This is especially relevant in the digital media field where emerging creators, or web-casters who wish to remain independent, usually do not have the resources to acquire and maintain such services. Security of content distribution transaction is however, essential for such transactions and in the case of the web-caster is often a requirement set by the content providers. In a situation where such a barrier is removed, such independent content providers may also become their own vendors.

By removing the trust requirements competition is enhanced, providing for far more diverse market models and inventory. For example, a small, unknown web site which is hard to trust, could still act as a vendor, enjoying both the benefits of participation in the distribution chain and of access to advertisers, while enlarging the market for a specialized subset of the available content by providing access to its users and providing a focused target for advertisers.

Removing the trust requirement and providing an alternative, less costly and simpler solution for both sides, will therefore serve both sides and the whole market will benefit from the growing diversity and number of transactions.

When regarding the infrastructure of digital media distribution chains, here also the removal of the trust barrier, requiring the setting up of hardware dedicated for this purpose is expressed by the reduction of technological and physical barriers.

Methods for providing assurance for online transactions are known.

U.S. patent application Ser. No. 2001/0027441 describes a system and method for conducting electronic commerce with a remote wallet server. The remote wallet server conducts a transaction with a merchant computer in a format substantially compliant with a chip card electronic commerce protocol or specification, regardless of whether or not the payment card of the consumer involved in the transaction is a chip card. The disclosure requires the issuing or the existence of physical credentials for the consumer by a third party, and does not relate to the field of digital media.

U.S. patent application Ser. No. 2001/0011255 describes a method of managing reliance in an electronic transaction system. The method includes a certification authority issuing a primary certificate to a subscriber and forwarding to a reliance server, information about the issued primary certificate. The reliance server maintains the forwarded information about issued primary certificate. The subscriber forms a transaction and then provides the transaction to a relying party. The transaction includes the primary certificate or a reference thereto. The relying party sends to the reliance server a request for assurance based on the transaction received from the subscriber. The reliance server determines whether to provide the requested assurance based on the information about the issued primary certificate and on the requested assurance. Based on the determination, the reliance server issues to the relying party a secondary certificate providing the assurance to the relying party.

Again, this invention relies on issuing a certificate to the consumer.

All the above-mentioned methods include the accumulation of data on the certified body (usually, the consumer), gathered in prior transactions.

U.S. patent application Ser. No. 2001/0018675 presents a method and apparatus for compliance checking in a trust-management system. A request r, a policy, and n−1 credential assertions are received, each credential assertion comprising a credential function and a credential source. Each assertion may be monotonic, authentic, and locally bounded. Each assertion is run and the result is added to the acceptance record set. This is repeated (m×n) times, where m represents a number greater than 1, and an acceptance is output if any of the results in the acceptance record set comprise an acceptance record.

U.S. Pat. No. 5,917,912 provides systems and methods for secure transaction management and electronic rights protection. Electronic appliances such as computers equipped in accordance with the disclosed invention help to ensure that information is accessed and used only in authorized ways, and maintain the integrity, availability, and/or confidentiality of the information. Such electronic appliances provide a distributed virtual distribution environment (VDE) that may enforce a secure chain of handling and control, for example, to control and/or meter or otherwise monitor use of electronically stored or disseminated information. Such a virtual distribution environment may be used to protect rights of various participants in electronic commerce and other electronic or electronic-facilitated transactions. Distributed and other operating systems, environments and architectures, such as, for example, those using tamper-resistant hardware-based processors, may establish security at each node. These techniques may be used to support all-electronic information distribution, for example, utilizing the “electronic highway.” The disclosure suggests the creation of a secure environment, wherein transactions are limited to the ‘members’ of such environment.

Creating such secured environments and/or requiring an encryption key or credential from a third party, which is not available on the Internet is a bottle neck in the transaction.

There is thus a recognized need for, and it would be highly advantageous to have, a method and system that allows distribution of digital media and conduction of electronic commerce in an un-trusted environment, which overcomes the drawbacks of current methods as described above.

### SUMMARY OF THE INVENTION

The present embodiments provide a method and a system for the incorporation of several parties in the distribution of digital and physical goods, in a manner that limits trust requirements, is described. The method is based on the incorporation of a centralized trusted entity that verifies, authenticates and audits the transactions. The system may be designed and implemented as an integral component of a digital media distribution system.

According to a first aspect of the present invention there is provided a method for secure distribution of digital content held in at least one content server over an electronic network comprising the steps of:

on the network setting up at least one centralized trusted entity for at least one of verifying, authenticating and auditing transactions,

at the centralized trusted entity receiving a request from a vendor to verify a transaction involving a transaction client identified in the request,

at the centralized trusted entity sending a verification request to the identified transaction client, receiving at the centralized trusted entity a verification reply from the transaction client, and

upon receipt of the verification reply sending a transaction approval signal to the vendor and to the content server, thereby to signal to the content server approval to release the digital content.

In another embodiment of the present invention the request received from the vendor is expected to include a cryptographic signature identifying the vendor and the receiving the request from the vendor comprises verifying the cryptographic signature.

In another embodiment of the present invention the digital content comprises at least one of the following media types:

text;

video;

audio;

image;

software;

game;

rich text:

formatted text;

hypertext; and

multimedia.

In another embodiment of the present invention the transaction related information stored in the centralized trusted entity is further usable for at least one of the following additional purposes;

auditing;

accounting;

invoicing; and

creating a trustability rating for participants in the transaction.

In another embodiment of the present invention further comprising use of at least one of the following:

cryptographic methods;

ID used instead of actual data; and

ID identifying the transaction.

In another embodiment of the present invention further comprising providing the transaction client with a tamper resistant software module for sending transaction related information comprising at least the verification reply to the verifier with at least some independence from a user of the client.

In another embodiment of the present invention the transaction related information further comprises at least one of the following:

price;

method of payment;

identification of the digital content;

identification of a user of the client;

planned quality of delivery;

actual quality of delivery;

quality of content;

planned speed of delivery;

actual speed of delivery;

ad information;

demographic information;

technical information;

method of delivery;

cryptographic information;

public key;

private key;

information used to control the use of the digital media delivered to the client; and

information about the usage restriction of the digital media.

In another embodiment of the present invention the central trusted entity connects over the electronic network to at least one of the following:

an insurer operable to insure the transaction;

a content provider operable to provide the digital content for the transaction; and

a payment service operable to receive payment for the transaction.

According to a second aspect of the present invention there is provided a method for secure distribution of digital content around an electronic network, the method being executed using at least four data processors connected via the network and comprising:

at a first of the data processors sending transaction related information to a second of the data processors;

at the second data processor, storing at least some of the transaction related information; and

at the second data processor, assuring a third data processor that the first data processor has sent the transaction related information to the second data processor;

the transaction being for the purpose of distribution of the digital content; and the data processors comprise the following:

at least one vendor;

at least one client;

at least one content server operable to deliver the digital content to the client; and

at least one verifier;

and the second data processor is the verifier.

In another embodiment of the present invention the digital content comprises at least one of the following media types:

text;

video;

audio;

image;

software;

game;

rich text;

formatted text;

hypertext; and

multimedia.

In another embodiment of the present invention the transaction related information stored in the verifier is further used for at least one of the following additional purposes:

auditing;

accounting;

invoicing; and

creating a trustability rating for at least one of the entities operating at least one of the data processors.

In another embodiment of the present invention the method further comprises the usage of at least one of the following:

cryptographic methods;

ID used instead of actual data; and

ID identifying the transaction.

In another embodiment of the present invention the client further contains at least one tamper resistant module operable to send transaction related information to the verifier with at least some independence from the entity operating the client.

In another embodiment of the present invention the transaction related information comprises at least one of the following:

price;

method of payment;

identification of the digital media;

identification of entity operating the client;

planned quality of delivery;

actual quality of delivery;

quality of content;

planned speed of delivery;

actual speed of delivery;

ad information;

demographic information;

technical information;

method of delivery;

cryptographic information;

public key;

private key;

information used to control the use of the digital media delivered to the client; and

information about the usage restriction of the digital media.

In another embodiment of the present invention the data processors further comprise at least one of the following:

an insurer operable to insure the transaction;

a content provider operable to provide the digital media for the transaction; and

a payment service operable to receive payment for the transaction.

According to a third aspect of the present invention there is provided an apparatus for verifying secure distribution of digital content held at a content server over an electronic network comprising:

a vendor request receiver for receiving a request from a vendor to verify a transaction involving a transaction client identified in the request,

a client verification sender for sending a verification request to the identified transaction client,

a client verification reply receiver for receiving at the centralized trusted entity a verification reply from the transaction client, and

a transaction approver, associated with the client verification reply receiver for sending transaction approval signals to the vendor and to the content server, upon receipt of the verification reply, thereby to signal to the content server approval to release the digital content.

In another embodiment of the present invention request received from the vendor is expected to include a cryptographic signature identifying the vendor and the vendor request receiver comprises cryptographic verification functionality for verifying the cryptographic signature

The present invention successfully addresses the shortcomings of the presently known configurations by providing a method and system for distribution of digital media and conduction of electronic commerce in an un-trusted environment that can efficiently serve the current needs.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be be most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a simplified block diagram of a system for distribution of digital media and conduction of electronic commerce, constructed and operative according to a preferred embodiment of the present invention;

FIG. 2 is a simplified block diagram of another preferred embodiment of the system, similar to that described in FIG. 1, but wherein a verifier also verifies that the content was properly delivered;

FIG. 3 is a simplified block diagram of another preferred embodiment of the system, similar to that described in FIG. 1, but wherein another entity, the content provider, utilizes the services of the verifier;

FIG. 4 is a simplified block diagram of another preferred embodiment of the system, similar to that described in FIG. 1, but wherein the verifier uses an audit database in order to store data regarding the various transactions, client's records, etc;

FIG. 5 is a simplified block diagram of another preferred embodiment of the system, similar to that described in FIG. 4, but wherein the verifier contacts an insurance entity in order to insure the transaction, and

FIG. 6 is a simplified block diagram of another preferred embodiment of the system, similar to that described in FIG. 5, but wherein the verifier contacts a payment entity.

### DETAILED DESCRIPTION OF THE PREFERRED EMBODIMENTS

The present embodiments describe a method and system for distribution of digital media and conduction of electronic commerce in an untrusted environment.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. In addition, it is to be understood that the phraseology and terminology employed herein is for the purpose of description and should not be regarded as limiting.

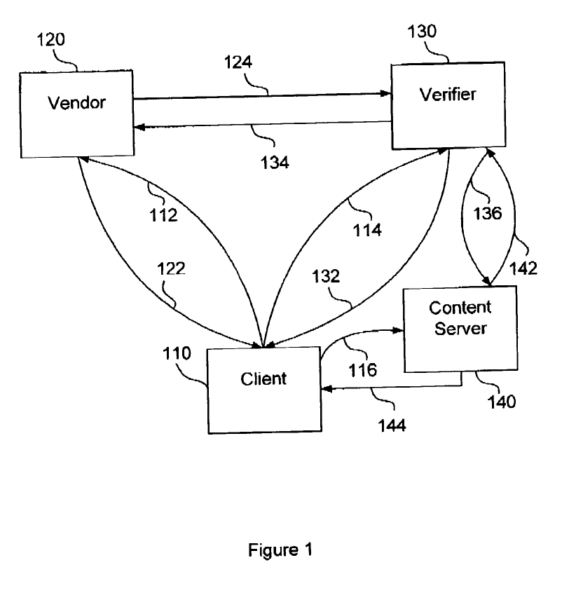

Reference is first made to FIG. 1, which is a simplified block diagram of a preferred embodiment of the system. A client 110, a vendor 120, a verifier 130 and a content server 140 are connected over a network such as the Internet. Specifically, the client 110 has separate connections 112, 114, and 116 to each of the vendor 120, the verifier 130 and the content server 140 respectively. The vendor has connections 122 and 124 to the client 110 and the verifier 130 respectively. The verifier 130 has connections 132, 134 and 136 to the client, the vendor and the content server respectively. The content server 140 has connections 142 and 144 to the client and the verifier respectively.

In the following, a reference numeral followed by ‘s’ indicates a signal or communication sent along the communication link indicated by the number. The client 110 sends the vendor 120 a request 112s to buy digital content. The vendor 120 sends to the client 110 a form 122s, which describes the details of the transaction and the required data that the consumer needs to provide (c.g., credit-card number) as well as details about how to contact the content server. The vendor also sends the details of the transaction 124s to the verifier 130, preferably encrypted and signed with the vendor's digital signature. The verifier 130 then sends the client 110 a request for confirmation (RFC) 132s. The client 110 sends the verifier 130 a confirmation 114s. The verifier 130 then sends the vendor 120 an approval message 134s and to the content server 140 an approval 136s. Upon receiving the approval, the content server 140 sends the client 110 the desired content 144s.

In another preferred embodiment of the present invention, the transfer of the desired content is initiated by the client 110, who sends the content server 140 an approval request 116s, approved in the aforementioned reply 136s. The approval initiates a further request 142s from the content server 140 to the verifier 130. In another preferred embodiment of the present invention, the vendor instructs the client, as a part of the process, to send the details of the transaction to the verifier 130, together with the confirmation 114s.

Note that the content server can also be the verifier or the vendor or otherwise known to the client, in which case the information can be sent in a later stage, separating it from the form 122s, especially in the case where the exchange of information between the client and vendor is composed of several stages, e.g. the client also need to approve the form 122s to the vendor or to fill in some details which the vendor may need to approve in turn.

In another preferred embodiment of the present invention, the client 110 sends the vendor 120 the request for confirmation 132s as it arrives from the verifier 130.

In another preferred embodiment of the present invention, the request for confirmation is made by the vendor 120 as a part of the form exchange 122s.

Note that all these information exchanges are preferably protected by encryption, authentication and verification methods (e.g. cryptographically signed). Furthermore each information exchange may contain additional information beyond that which was described above. Furthermore, information as described above can be omitted in order to achieve privacy or secrecy goals, and information may be added to compensate for omitted information, such as temporary IDs. Also note that all exchanges may be composed of several unilateral bilateral or multilateral stages.

Information can also be virtually sent: for example the vendor could send the details of the transaction to the verifier by encrypting and signing the information, preferably with a time stamp and/or temporary ID and/or other methods to prevent tampering, transfer the result to the client and expect it to transfer it to the verifier where it would be decrypted and verified.

Note that the various alternatives mentioned above also apply to the embodiments described hereafter.

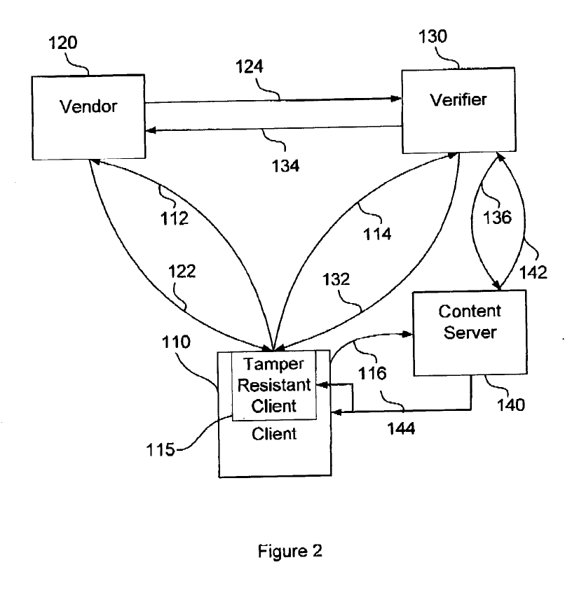

Reference is now made to FIG. 2, which is a simplified block diagram of another preferred embodiment of the system, similar to that described in FIG. 1, but wherein the verifier 130 also verifies that the content was properly delivered. The client additionally comprises a tamper-resistant client software unit 115. In the embodiment of FIG. 2, the vendor preferably describes the size of the content and/or computes a digital hash of the content and sends this information as a part of the details of the transaction 124s that are sent to the verifier 130. In the request for confirmation 132s, the verifier asks the client to confirm the size and/or the hash of the content and sends confirmation data to the verifier. The confirmation is preferably performed by the tamper-resistant client software 115.

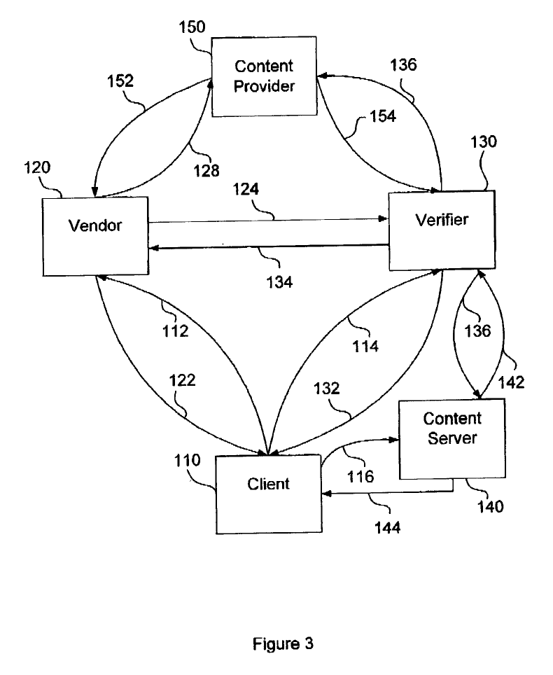

Reference is now made to FIG. 3, which is a simplified block diagram of another preferred embodiment of the system, similar to that described in FIG. 1, but with additional connections to a content provider 150. More particularly, content provider 150 supports connections 152 to the vendor 120 and 154 to the verifier 130. The vendor 120 has a connection 128 to the content provider 150 and the verifier 130 has a connection 136 to the content provider 150. The content provider 150, is able to utilize the services of the verifier 130. The content provider 150 forms a contract 152s with the vendor 120, an additional copy of which, 154s, is sent to the verifier 130. The vendor 120 sends the details of transactions 128s to the content provider 150, and the verifier 130 sends verification 136s to the content server 140. A similar scenario could include sending a copy of the contract signal to the content server 140 or making the initial contract with the content server 140.

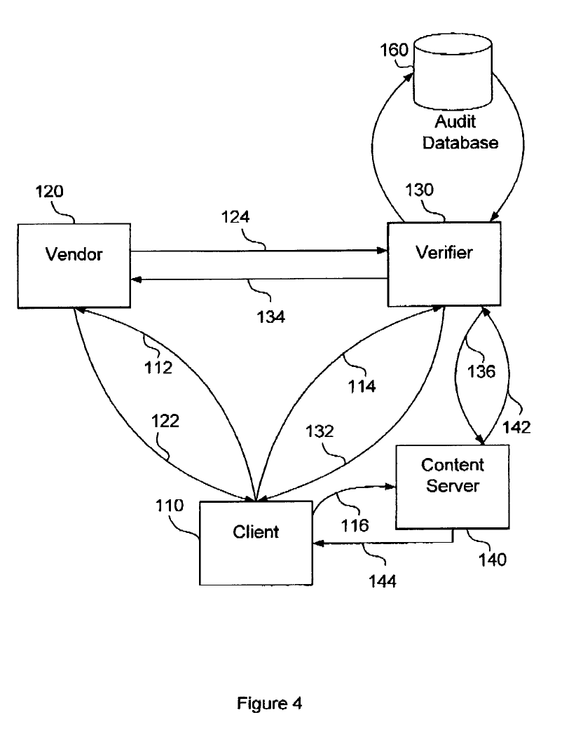

Reference is now made to FIG. 4, which is a simplified block diagram of another preferred embodiment of the system, similar to the one described in FIG. 1, with the addition that the verifier 130 uses an audit database 160 in order to store data regarding the various transactions, client's records, data regarding suspicious activity of users, demographic data etc. This data can be used in order to estimate the potential risk from various clients and to decide which authentication and protection methods are needed. The audit database 160 is preferably associated with the verifier 130 via a two-way data connection.

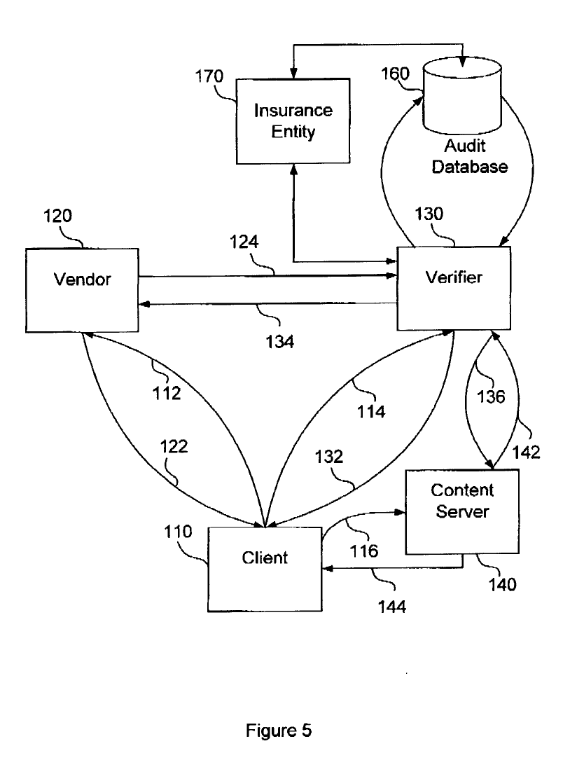

Reference is now made to FIG. 5, which is a simplified block diagram of another preferred embodiment of the system. The embodiment of FIG. 5 is similar to that described in FIG. 4, but in addition an insurance entity 170 is associated with both the verifier 130 and the audit database 160 via two-way data connections. The verifier 130 contacts the insurance entity 170 in order to insure transactions, and thereby limits the risks of the vendor and/or the client. The premium rate for insurance can be evaluated based on the data that is stored in the database 160.

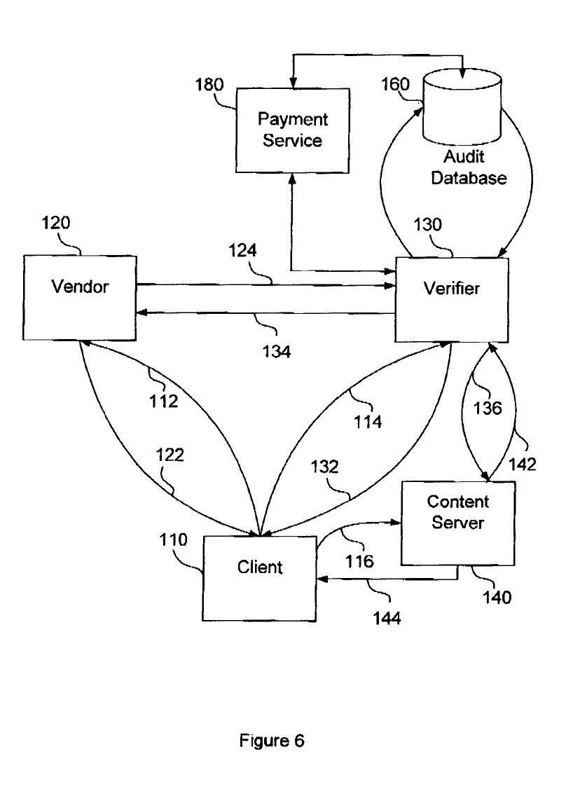

Reference is now made to FIG. 6, which is a simplified block diagram of another preferred embodiment of the system. The embodiment of FIG. 6 is similar to that described in FIG. 4, but in addition a payment service 180 is associated with both the verifier 130 and the audit database 160 via two-way data connections. In the embodiment of FIG. 6, the verifier 130 contacts a payment service 180, in order to receive payment for the transaction.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

It will be appreciated by persons skilled in the art that the present invention is not limited to what has been particularly shown and described hereinabove. Rather the scope of the present invention is defined by the appended claims and includes both combinations and subcombinations of the various features described hereinabove as well as variations and modifications thereof, which would occur to persons skilled in the art upon reading the foregoing description.

1. A method for secure distribution of digital content held in at least one content server over an electronic network comprising the steps of:
on said network setting up at least one centralized trusted entity for at least one of verifying, authenticating and auditing transactions,
at said centralized trusted entity receiving a request from a vendor to verify a transaction involving a transaction client identified in said request,
at said centralized trusted entity sending a verification request to said identified transaction client, receiving at said centralized trusted entity a verification reply from said transaction client, and
upon receipt of said verification reply sending a transaction approval signal to said vendor and to said content server, thereby to signal to said content server approval to release said digital content.

2. The method of claim 1, wherein said request received from said vendor is expected to include a cryptographic signature identifying said vendor and wherein said receiving said request from said vendor comprises verifying said cryptographic signature.

3. The method of claim 1, wherein said digital content comprises at least one of the following media types:
text;
video;
audio;
image;
software;
game;
rich text;
formatted text;
hypertext; and
multimedia.

4. The method of claim 1, wherein said transaction related information stored in said centralized trusted entity is further usable for at least one of the following additional purposes:
auditing;
accounting;
invoicing; and
creating a trustability rating for participants in said transaction.

5. The method of claim 1, further comprising use of at least one of the following:
cryptographic methods;
ID used instead of actual data; and
ID identifying said transaction.

6. The method of claim 1, further comprising providing said transaction client with a tamper resistant software module for sending transaction related information comprising at least said verification reply to said verifier with at least some independence from a user of said client.

7. The method of claim 1, wherein said transaction related information further comprises at least one of the following:
price;
method of payment;
identification of said digital content;
identification of a user of said client;
planned quality of delivery;
actual quality of delivery;
quality of content;
planned speed of delivery;
actual speed of delivery;
ad information;
demographic information;
technical information;
method of delivery;
cryptographic information;
public key;
private key;
information used to control the use of said digital media delivered to said client; and
information about the usage restriction of said digital media.

8. The method of claim 1, wherein said central trusted entity connects over said electronic network to at least one of the following:
an insurer operable to insure said transaction;
a content provider operable to provide said digital content for said transaction; and
a payment service operable to receive payment for said transaction.

9. A method for secure distribution of digital content around an electronic network, the method being executed using at least four data processors connected via said network and comprising:
at a first of said data processors, sending transaction related information to a second of said data processors;
at said second data processor, storing at least some of said transaction related information; and
at said second data processor, assuring a third data processor that said first data processor has sent said transaction related information to said second data processor;
said transaction being for the purpose of distribution of said digital content; and wherein said data processors comprise the following:
at least one vendor;
at least one client;
at least one content server operable to deliver said digital content to said client; and
at least one verifier;
and wherein said second data processor is said verifier.

10. The method of claim 9, wherein said digital content comprises at least one of the following media types:
text;
video;
audio;
image;
software;
game;
rich text;
formatted text;
hypertext; and
multimedia.

11. The method of claim 9, wherein said transaction related information stored in said verifier is further used for at least one of the following additional purposes:
auditing;
accounting;
invoicing; and
creating a trustability rating for at least one of the entities operating at least one of said data processors.

12. The method of claim 9, wherein said method further comprises the usage of at least one of the following:
cryptographic methods;
ID used instead of actual data; and
ID identifying said transaction.

13. The method of claim 9, wherein said client further contains at least one tamper resistant module operable to send transaction related information to said verifier with at least some independence from the entity operating said client.

14. The method of claim 9, wherein said transaction related information comprises at least one of the following:
price;
method of payment;
identification of said digital media;
identification of entity operating said client;
planned quality of delivery;
actual quality of delivery;
quality of content;
planned speed of delivery;
actual speed of delivery;
ad information;
demographic information;
technical information;
method of delivery;
cryptographic information;
public key;
private key;
information used to control the use of said digital media delivered to said client; and
information about the usage restriction of said digital media.

15. The method of claim 9, wherein said data processors further comprise at least one of the following:
an insurer operable to insure said transaction;
a content provider operable to provide said digital media for said transaction; and
a payment service operable to receive payment for said transaction.

16. Apparatus for verifying secure distribution of digital content held at a content server over an electronic network comprising:
a vendor request receiver for receiving a request from a vendor to verify a transaction involving a transaction client identified in said request,
a client verification sender for sending a verification request to said identified transaction client,
a client verification reply receiver for receiving at said centralized trusted entity a verification reply from said transaction client, and
a transaction approver, associated with said client verification reply receiver for sending transaction approval signals to said vendor and to said content server, upon receipt of said verification reply, thereby to signal to said content server approval to release said digital content.

17. The apparatus of claim 16, wherein said request received from said vendor is expected to include a cryptographic signature identifying said vendor and wherein said vendor request receiver comprises cryptographic verification functionality for verifying said cryptographic signature.
